(19) United States
(12) Patent Application Publication
(10) Pub. No.: US 2005/0144608 A1
(43) Pub. Date: Jun. 30, 2005

(54) Operating system allowing running of real-time application programs, control method therefor, and method of loading dynamic link libraries

(76) Inventors: Hiroshi Oyama, Niwa-gun (JP); Chiaki Kawahara, Hadano-shi (JP); Koji Tanaka, Niwa-gun (JP); Toru Terada, Mandelieu La Napoule (FR)

Correspondence Address: Gauthier & Connors LLP, Suite 3300, 225 Franklin Street, Boston, MA, 02110, US

(21) Appl. No.: 11/018,538

(22) Filed: Dec. 21, 2004

(30) Foreign Application Priority Data
Dec. 26, 2003 (JP) 2003-435554

(51) Int. Cl. G06F 9/44

(52) U.S. Cl. 717/162; 717/148

(57) ABSTRACT

The present invention provides a device driver that loads dynamic link libraries, which include the RTOS function and real-time applications, into the kernel space and starts the dynamic link libraries. The RTOS function and real-time applications are configured as dynamic link libraries. The device driver loads into the kernel space a dynamic link library and other dynamic link libraries referenced by the dynamic link library, adjusts address information on the basis of relocation information, resolves external references, acquires symbol information indicating a start function, and starts the start function.

### CROSS-REFERENCE TO RELATED APPLICATION(S)

The entire disclosure of Japanese Patent Application No. 2003-435554 including specification, claims, drawings and abstract is incorporated herein by reference.

### BACKGROUND OF THE INVENTION

1. Field of the Invention

The present invention relates to an operating system in which real-time application programs can run, to a control method therefor, and to a method of loading dynamic link libraries, and more particularly to the control of real-time application programs in an operating system in which the application program memory space and the kernel memory space are allocated as different memory spaces and in which a device driver that controls an input/output device is installed in the kernel memory space.

2. Description of the Related Art

Conventionally, application program memory space and kernel memory space are allocated as different memory spaces and, in many cases, an operating system, in which a device driver for controlling an input/output device is installed in the kernel memory space, does not have a real-time operating system function (hereinafter called an RTOS function). Therefore, even if many useful application programs run only in such an operating system, an application requiring the RTOS function; that is, a real-time application, cannot run in such an operating system unless the RTOS function is provided and, in addition, an application requiring the RTOS function cannot be used with other useful application programs.

### SUMMARY OF THE INVENTION

When the RTOS function is built into such an operating system, the RTOS function is sometimes installed as a device driver. In this case, because the exchange of a device driver is managed by the operating system, the device driver cannot be exchanged unless the limitation conditions of the operating system are satisfied. Therefore, the RTOS function cannot be exchanged easily.

In addition, such an operating system is not designed for loading application software into the kernel space for execution. Thus, means is required for loading a real-time application, which uses the RTOS function, into the kernel space and starting it therein. Desirably, such a function is implemented not as an RTOS function but as a function separate from the RTOS function.

In view of the problems described above, the present invention provides an operating system in which an application program memory space and a kernel memory space are set up as different memory spaces, and a device driver for controlling an input/output device is installed in the kernel memory space, wherein real-time operating system and a real-time application are configured as a dynamic link library. The provided device driver, which loads dynamic link libraries, reads into the kernel space, performs relocation for, resolves external references of, and starts the real-time operating system and the real-time application. In this way, the present invention provides an operating system and a control method therefor that make the RTOS function available in an operating system not having the RTOS function and that enable loading of the RTOS function and real-time applications, which are configured as dynamic link libraries, as a plurality of dynamic link libraries.

For use in the case where a library including a symbol externally referenced by a dynamic link library is not yet loaded, the present invention provides a method of automatically loading a necessary dynamic link library by reading, performing relocation for, resolving external references of, and starting the dynamic link library.

Alternatively, the present invention provides a method for specifying a list of dynamic link libraries to be loaded as a list, for reading, performing relocation for, and resolving the external references of, the specified dynamic link libraries, and for starting the dynamic link libraries in a sequence specified in the list in order to implement the load function that allows explicit specification of the load and start sequences of the necessary dynamic link libraries. The list does not have to be of a data structure, and may assume the form of an array.

In addition, when resolving external references, the present invention allows only the real-time operating system and limited real-time applications to reference the symbols of the kernel memory space of the operating system and prevents calling of the kernel function of the operating system, which should not be called by a real-time application.

In addition, the present invention sets an area of the kernel memory space, in which the instruction code section and the read-only initialized data section are loaded, to a read-only area after the real-time operating system and a real-time application are read into the kernel space. This ensures protection against an invalid write operation.

The device driver according to the present invention reads into the kernel space a dynamic link library, and other dynamic link libraries referenced by the dynamic link library, adjusts the address information on the basis of the relocation (rearrangement) information, resolves the external references, obtains symbol information indicating the start function, and starts the start function.

In addition, the device driver according to the present invention determines if the dynamic link library is real-time operating system or a particular real-time application and, if so, allows the library to reference the symbols of the kernel of the operating system; that is, allows the library to call a kernel function.

In addition, through the operation of the memory management table after the real-time operating system and a real-time application are loaded into the kernel space, the device driver according to the present invention sets to a read-only area an area in the kernel memory space into which the instruction code section and the read-only initialized data section are loaded.

In addition, the device driver according to the present invention is recorded on a recording medium.

With the RTOS function and real-time applications configured as dynamic link libraries, the device driver according to the present invention that loads dynamic link libraries reads into the kernel space a dynamic link library, and other dynamic link libraries referenced by the dynamic link library, adjusts the address information on the basis of the relocation (rearrangement) information, resolves the external references, obtains symbol information indicating a start function, and starts the start function. The RTOS function and real-time applications are easy to build; the only requirement is to build them as dynamic link libraries.

Because referenced dynamic link libraries are selected and loaded recursively, the referenced dynamic link libraries are automatically loaded by simply specifying and loading the dynamic link library of the highest-level real-time application. The advantage of this method is that the procedure for specifying each dynamic link library can be omitted and the dynamic link libraries are started in an appropriate sequence.

Meanwhile, when the dynamic link libraries to be loaded must be managed strictly, all dynamic link libraries to be loaded can be specified in advance and the sequence in which they are to be started can be specified. This prevents an error that may otherwise occur when the dynamic link libraries are started in an unexpected sequence.

### BRIEF DESCRIPTION OF THE DRAWINGS

FIG. 1 is a diagram showing an application memory space 1, a kernel memory space 8, and software components stored therein according to the present invention.

FIG. 2 is a block diagram showing a computer system.

FIG. 3 is a diagram showing the structure of a dynamic link library.

FIG. 4 is a flowchart showing a procedure used by a dynamic-link-library loading device driver for loading dynamic link libraries.

FIG. 5 is a diagram showing the structure of relocation information.

FIG. 6 is a diagram showing the structure of export information.

FIG. 7 is a diagram showing the structure of import information.

FIG. 8 is a flowchart showing a procedure for starting the start function of dynamic link libraries.

FIG. 9 is a flowchart showing the operation of a second device driver that loads dynamic link libraries.

### DESCRIPTION OF PREFERRED EMBODIMENTS

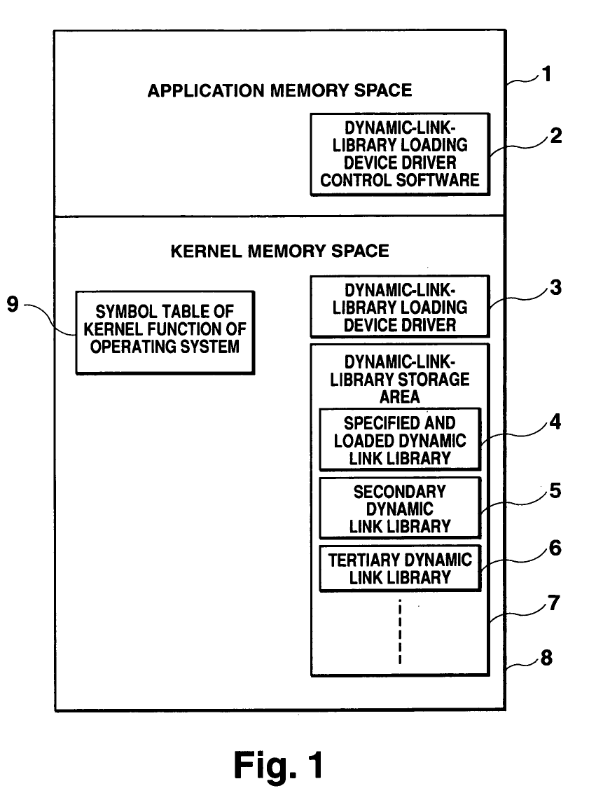

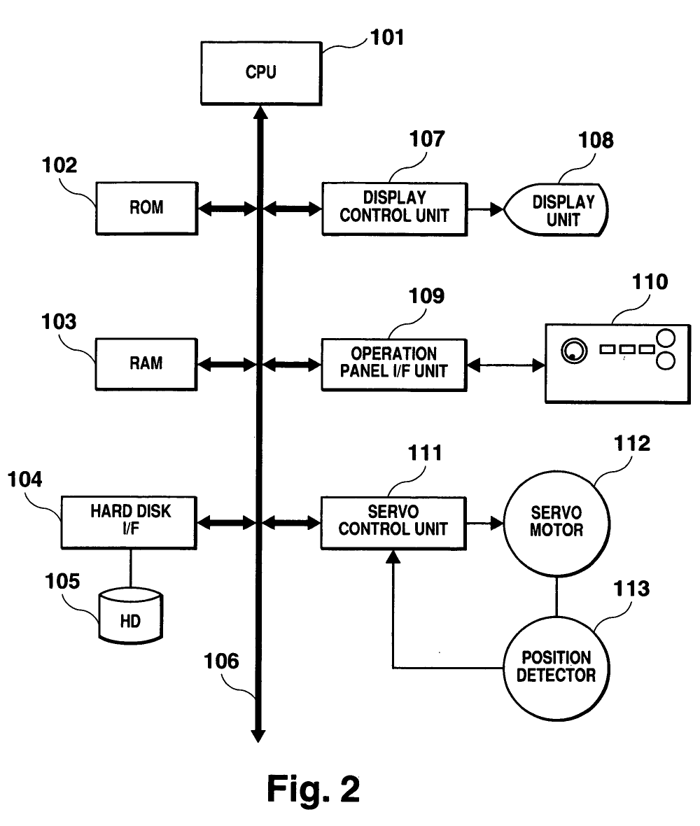

FIG. 1 is a diagram showing an application memory space 1, a kernel memory space 8, and the software installed in these memory spaces according to the present invention. These memory spaces are provided in RAM 103 of a computer system shown in the block diagram in FIG. 2. A CPU 101 must have a memory management unit (MMU), not shown in FIG. 2, in order to treat the application program memory space and the kernel memory space as separate memory spaces. FIG. 1 shows only the components related to the present invention. In actuality, the main module that implements the kernel function, various device driver functions, and other functions is also provided. Referring to FIG. 1, the kernel memory space 8 contains a dynamic-link-library loading device driver 3 according to the present invention and a dynamic link library storage area 7 allocated by the dynamic-link-library loading device driver 3. The dynamic link library storage area 7 contains a dynamic link library 4 specified and loaded by the dynamic-link-library loading device driver 3, a secondary dynamic link library 5 referenced by the specified and loaded dynamic link library 4, and a tertiary dynamic link library 6 referenced by the secondary dynamic link library 5.

FIG. 2 shows a computer system for NC controlling, for example, the main axis or the feed rod mechanism of a machine tool. A servo motor 112 is controlled by a servo control unit 111, the positions of the main axis and other feed rods are detected by a position detector 113, and the servo control unit 111 performs high-precision position control. The servo control unit 111 is connected to the CPU 101 via a system bus 106 to which an operation panel I/F (interface) unit 109 and a display control unit 107 are connected. The operation panel I/F unit 109, connected to an operation board 110 operated by the operator of the machine tool, sends a desired processing command to the CPU 101. The processing status of the machine tool is sent from the display control unit 107 to a display unit 108 to allow the operator to always monitor the current status of the NC control.

ROM 102, the RAM 103, and a hard disk I/F 104 are also connected to the system bus 106 described above. The hard disk I/F 104 reads data from, and writes data to, a hard disk 105. In response to an instruction from the CPU 101, desired control data are read from the memory devices and necessary past data are written. As described above, the present invention relates to the operating system controlled by the CPU 101 and the RAM 103 shown in FIG. 2.

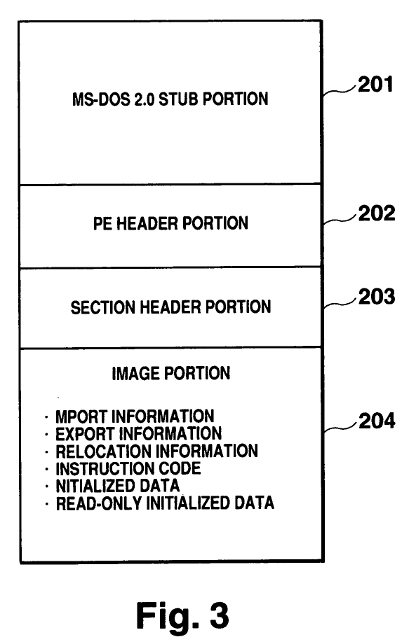

FIG. 3 is a diagram showing the structure of Microsoft's dynamic link library (DLL: Dynamic Link Library) extracted and summarized from “Microsoft Portable Executable and Common Object File Format Specification” (Microsoft Corp.). The following description is based on the structure of this dynamic link library.

The dynamic link libraries are first stored on the hard disk (HD) 105 as files. Usually, dynamic link libraries are referenced by an application program and loaded into the application memory space. This loading job is usually executed by the operating system or a library provided with the operating system. By contrast, the dynamic-link-library loading device driver 3 according to the present invention reads those libraries into the kernel memory space 8 and starts the start function.

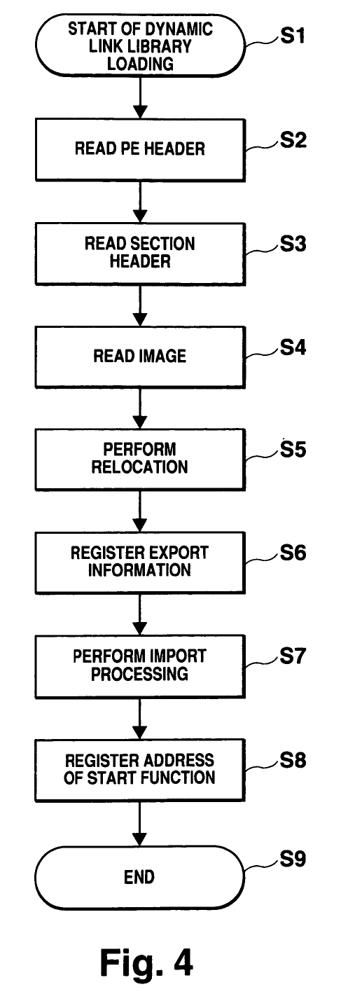

FIG. 4 is a flowchart showing the procedure executed by the dynamic-link-library loading device driver 3 for loading dynamic link libraries. The operation of the dynamic-link-library loading device driver 3 will be described below with reference to this flowchart.

The dynamic-link-library loading device driver 3 starts operation in response to an instruction from dynamic-link-library loading device driver control software 2 (Si).

First, the dynamic-link-library loading device driver 3 reads into the dynamic link library storage area 7 a PE header 202 (FIG. 3) of a specified dynamic link library (S2). The PE header contains the number of sections and the size of an option header. The option header, which is a part of the PE header, contains information necessary for properly loading a dynamic link library, such as version information, the size of a stack memory, the position of an export table within the file, and the position of an import table within the file.

Next, the device driver 3 reads a section header portion 203 (S3). The section header contains the section names and the sizes of the sections stored in an image portion 204, such as those of the import information, the export information, and the relocation information. Next, the device driver 3 reads the image portion 204 (S4). The image portion is divided into sections, each of which is read into an appropriate free area in the memory 103. In this way, the PE header 202, the section header 203, and the image 204 are read, and the specified and loaded dynamic link library 4 is loaded into the dynamic link library storage area 7. Note that, the .text section (instruction code, “.text” is the section name; this notation is used also in the description below) and the .rdata section (read-only initialized data), which are sections included in the image portion, are set to read-only by specifying ‘read-only’ in the memory management table managed by the MMU described above. By setting ‘read-only’ in this way, an invalid write operation on those areas is prevented and a correct action can be taken.

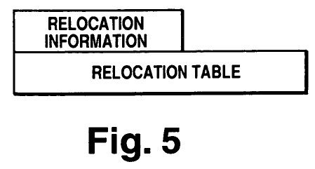

Next, on the basis of the relocation information stored in the .reloc section, the device driver 3 relocates the address information included in the instruction code stored in the .text section, the initialized data stored in the .data section, and the read-only initialized data stored in the .rdata section (S5). Relocation refers to adjustment of the difference between an address assumed when the dynamic link library is created and an address in the memory 103 at which data are actually loaded. More specifically, the address difference between the two addresses is added to or subtracted from the contents of the memory in which the address information is stored. FIG. 5 shows the structure of the relocation information. Only the relocation table is prepared as the relocation information. The structure of the relocation table is as follows. The first column contains the type of relocation method, and the second column contains an offset value indicating a memory address where the data are relocated. The table has as many rows as the addresses to be relocated.

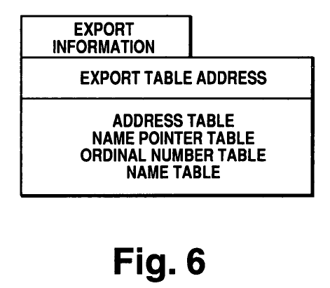

Next, the export information stored in the .edata section is registered in order to allow other dynamic link libraries to reference symbols (S6). FIG. 6 is a diagram showing the structure of the export information. The export information comprises an export table address, an address table, a name pointer table, an ordinal number table, and a name table. The export table address is information indicating where the tables that follow are allocated. The address table is a table containing export addresses in the sequence of ordinal number. The name pointer table and the ordinal number table are paired. Reading an address corresponding to a symbol (name) requires searching of the name pointer table, in which externally referenced symbols (names) are stored, for the name; reading an ordinal number with the array subscript of the found name as the subscript of the ordinal number table; and reading the address table on the basis of this ordinal number. Note that address information stored in the address table consists of addresses assumed at link time. Therefore, as described above in the description of the .reloc section (relocation information), the difference from the address of data actually read into the memory 103 must be adjusted.

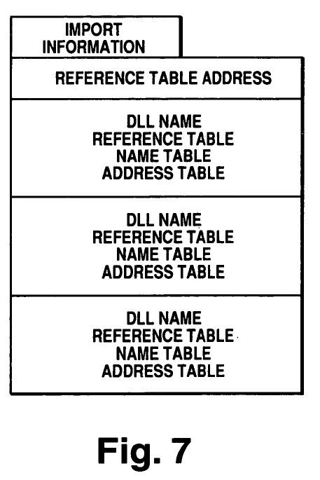

Next, the dynamic-link-library loading device driver 3 performs import processing on the basis of the import information stored in the .idata section (S7). FIG. 7 is a diagram showing the structure of the import information. When a dynamic link library references a symbol exported by some other dynamic link library, the import processing is performed in order to correct the address information in the reference table to an address associated with the exported symbol. If at this time the other dynamic link library has not yet been loaded, the export information on that dynamic link library has not yet been registered and therefore the symbol cannot be referenced. Therefore, that dynamic link library must be loaded. This processing is executed by executing the processing for the other dynamic link library beginning with step S1; that is, by executing recursive call processing. In this case, the device driver 3 searches a predetermined location on the hard disk 105, which is an auxiliary storage device, for the other library and loads the corresponding dynamic link library. Therefore, the referenced (dependent) dynamic link library is loaded automatically without specifying that the dynamic link library be loaded.

As a result of the recursive processing, the dynamic link library directly referenced by the specified and loaded dynamic link library 4 is loaded as the secondary dynamic link library 5, the dynamic link library referenced by the secondary dynamic link library is loaded as the tertiary dynamic link library 6, and the dynamic link library referenced by the nth dynamic link library is loaded as the (n+1)th dynamic link library, all into the dynamic link library storage area 7. Although the specified and loaded dynamic link library 4, the secondary dynamic link library 5, and the tertiary dynamic link library 6 are shown contiguously in FIG. 1, they are not always loaded in contiguous areas, but are sometimes loaded in separate areas in the actual memory.

If the dynamic link library specified by the dynamic-link-library loading device driver control software 2 is a real-time application, a dynamic link library having the RTOS function is included as one of the dynamic link libraries that are referenced. Therefore, the dynamic link library having the RTOS function is loaded with the real-time application.

Alternatively, it may be the case that, before loading a real-time application, the dynamic-link-library loading device driver control software 2 drives the dynamic-link-library loading device driver 3 with a dynamic link library having the RTOS function specified and then starts and loads the dynamic link library having the RTOS function before the real-time application. By doing so, the RTOS function is first started and, after the system operation becomes stable, the real-time application can be loaded and started.

If the dynamic link library to be loaded is real-time operating system or a particular real-time application, the symbol table 9 of the kernel function of the operating system can be referenced. This allows only the real-time operating system and limited real-time applications to call the kernel function of the operating system, which usually cannot be called, and thus prevents other real-time applications from issuing an invalid call to the function.

Finally, the dynamic-link-library loading device driver 3 registers the start address of the dynamic link library that has been loaded (S8). The symbol ‘main’ to be made accessible externally is found from the export information of the dynamic link library, and the address corresponding to that symbol is set to the start address. The symbol name does not have to be ‘main,’ but may be another symbol name. If this symbol is not found, the dynamic link library does not have to be started and therefore the start address need not be registered. The loading of the dynamic link library is ended in this step (S9).

As described above, executing steps S1 to S9 loads a specified dynamic link library, the secondary dynamic link library referenced by the specified dynamic link library, and the (n+1)th dynamic link library referenced by the nth (n=2, 3, 4, . . . ) dynamic link library. If multiple libraries are referenced by the specified dynamic link library or the nth library, multiple (n+1)th dynamic link libraries exist.

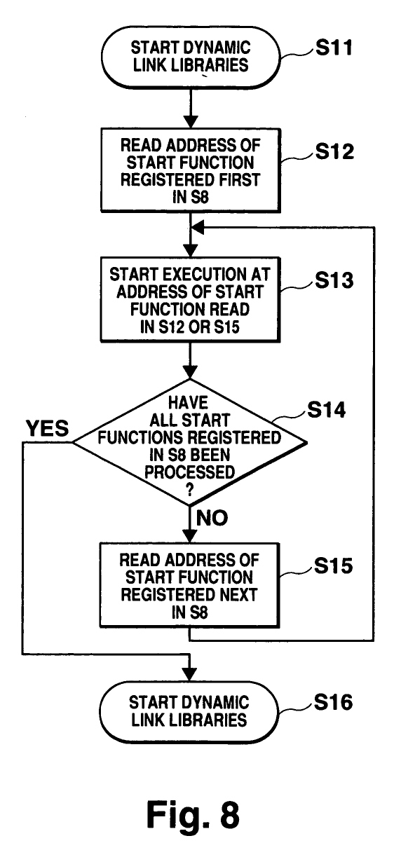

Next, with reference to the flowchart in FIG. 8, the following describes the procedure for obtaining symbol information indicating the start functions and for starting the start functions in the reverse sequence in which the dynamic link libraries are loaded. After all dynamic link libraries are loaded, the dynamic link libraries are started (S11). First, the start address registered first in step 8 of the loading procedure is obtained (S12). Next, execution is started at the start address read in step S12 (S13). This is a function call, and the start function is terminated immediately. A determination is made as to whether or not all start addresses registered in step 8 have been processed, and, if they have been processed, the procedure is terminated (S14). If there are start addresses that have not yet been processed, the start address registered next in step 8 is obtained (S15) and control is passed back to step S13 to repeat the procedure. Note that the sequence in which dynamic link libraries are registered in step S8 is the reverse sequence in which the dynamic link libraries are loaded and that, when started in this sequence, the dynamic link libraries are started in the reverse sequence in which they are loaded. This means that dependent dynamic link libraries are started, and preparation is made for them earlier. The operation of a first device driver that loads dynamic link libraries has been described. The dynamic link libraries are started after all dynamic link libraries are loaded, because there is a possibility that the dynamic link libraries are dependent on each other. If the dynamic link libraries are started before all dynamic link libraries are loaded, the function of a library that has not yet been loaded may be called.

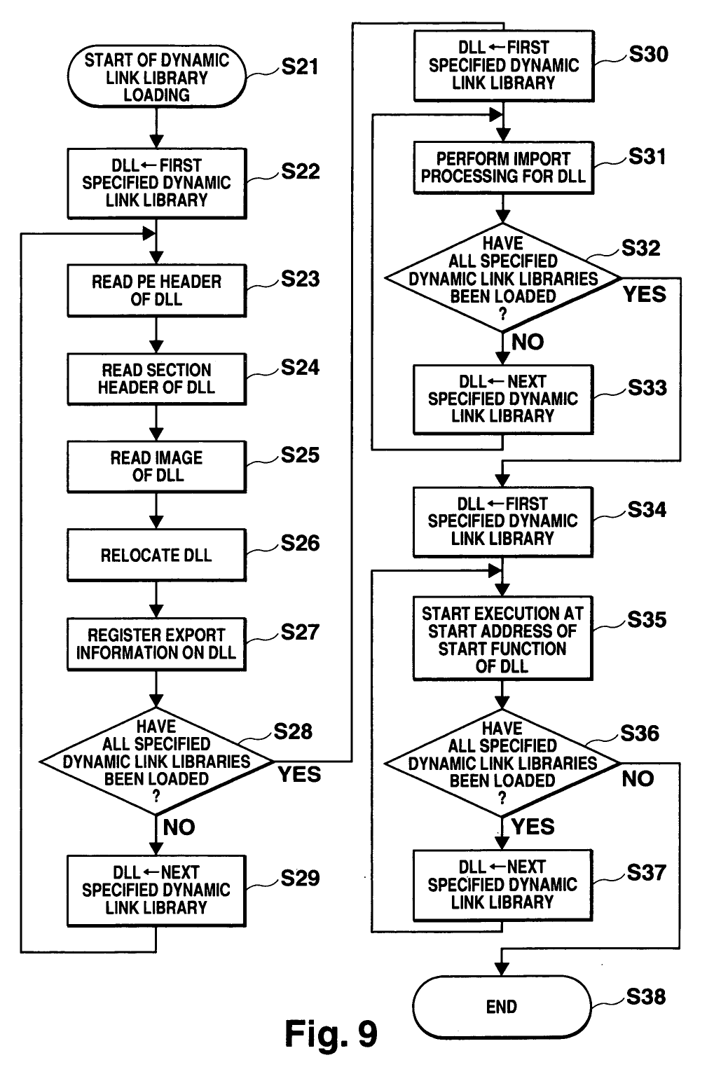

Next, with reference to the flowchart in FIG. 9, the operation of a second device driver that uses a different procedure for loading dynamic link libraries will be described.

The dynamic-link-library loading device driver 3 starts the operation in response to an instruction from the dynamic-link-library loading device driver control software 2 (S21). The name of the first dynamic link library included in a list of dynamic link libraries passed from, and specified by, the dynamic-link-library loading device driver control software 2 is stored in the variable dll (S22). The real-time control function is implemented by specifying a real-time application and the RTOS function for this list.

Next, the device driver 3 reads the PE header of the dynamic link library specified by the variable dll (S23), reads the section header (S24), reads the image (S25), performs the relocation (S26), and registers the export information (S27). Steps S23 to S27 correspond to steps S2 to S6 and their operations are similar to those in the aforementioned steps and, therefore, repeated description is omitted here.

If the specified dynamic link libraries are loaded, control is passed to step S30. Otherwise, the name of the next specified dynamic link library is set in the variable dll (S29) and control is passed back to step S23 for loading the dynamic link library.

In steps S30 to S33 that follow, the import processing is performed for all dynamic link libraries. The import processing in step S31 is the same as that in step S7 except that, if a symbol exported by some other dynamic link library is referenced, the other library is not loaded recursively because it is already loaded according to the list. Steps S30, S32, and S33 are loop control processing for performing the import processing for all dynamic link libraries.

Next, in steps S34 to S37, the execution starts at the start address of the start function of all dynamic link libraries. In step S35, the symbol ‘main’ to be made accessible externally is found from the export information of the dynamic link library dll and the execution starts with the address corresponding to the symbol as the start address. Steps S36 and S37 are loop control processing for starting the execution of all dynamic link libraries from the start address of the start function. The operation of the second device driver has been described. As with the first device driver, the instruction code memory and read-only initialized data section memory may be defined as read-only memories.

Although the description thus far pertains to what are considered to be preferred embodiments of the invention, it is to be understood that various modifications may be made thereto, and the appended claims are intended to cover all such modifications as falling within the true spirit and scope of the invention.

1. An operating system in which an application program memory space and a kernel memory space are set up as different memory spaces and a device driver for controlling an input/output device is installed in said kernel memory space, said operating system being capable of running a real-time application program, wherein real-time operating system and a real-time applications are configured as a dynamic link library, and the device driver reads into the kernel space, performs relocation for, resolves external references of, and starts the real-time operating system and the real-time application.

2. A control method of an operating system in which an application program memory space and a kernel memory space are set up as different memory spaces and a device driver for controlling an input/output device is installed in said kernel memory space, wherein
real-time operating system and a real-time application are configured as a dynamic link library, and
the device driver reads into the kernel space, performs relocation for, resolves external references of, and starts the real-time operating system and the real-time application for running the real-time application program.

3. A method of loading dynamic link libraries for use in the control method according to claim 2, wherein the device driver reads into the kernel space, performs relocation for, resolves external references of, and starts the real-time operating system and, subsequently, reads into the kernel space, performs relocation for, resolves external references of, and starts the real-time application.

4. The device driver for loading a dynamic link library for use in the operating system according to claim 1, wherein, if a symbol in a dynamic link library that not yet been loaded is included when the external references of the real-time operating system or the real-time application are resolved, said device driver reads into the kernel space, performs relocation for, resolves external references of, and starts the dynamic link library that has not yet been loaded.

5. A method of loading dynamic link libraries for use in the control method according to claim 2, wherein the device driver reads into the kernel space, performs relocation for, and resolves external references of the real-time operating system and real-time applications in accordance with a list thereof and, subsequently, starts the real-time operating system and real-time applications in accordance with a sequence specified in the list.

6. A method of loading dynamic link libraries for use in the control method according to claim 2 wherein, when the external references are resolved, the device driver allows symbols, which are owned by a kernel of the operating system, to be referenced only by the real-time operating system and limited real-time applications and prevents other real-time applications from referencing the symbols.

7. A method of loading dynamic link libraries for use in the control method according to claim 2 wherein, after the real-time operating system and real-time applications are read into the kernel space, the device driver sets to a read-only memory area an area of the kernel memory into which at least an instruction code section and a read-only initialized data section are loaded.

8. A recording medium storing therein the device driver according to claim 2.
